(19) United States
(12) Patent Application Publication
(10) Pub. No.: US 2006/0197841 A1
(43) Pub. Date: Sep. 7, 2006

(54) SELF-DIAGNOSTIC METHOD AND DEVICE FOR DIGITAL TELEVICION

(76) Inventors: Jenn-Shoou Young, Miao-Li County (TW); Wen-Ting Chen, Miao-Li County (TW)

Correspondence Address: NORTH AMERICA INTELLECTUAL PROPERTY CORPORATION, P.O. BOX 506, MERRIFIELD, VA, 22116, US

(21) Appl. No.: 11/306,197

(22) Filed: Dec. 19, 2005

(30) Foreign Application Priority Data
Jan. 5, 2005 (TW) 094100305

(51) Int. Cl. H04N 17/02

(52) U.S. Cl. 348/177; 348/189

(57) ABSTRACT

A digital television comprises at least one input interface for transmitting input signals, at least one processing unit connected to the input interface to receive the input signals and processing the input signals to output signals and then outputting the output signals, a scalar connected to the processing unit for receiving, adjusting and transmitting the output signals, a screen for displaying the output signals from the scalar, a diagnostic unit for generating a diagnostic signal, a storage unit and a starting unit for generating a starting signal and transmitting to the diagnostic unit to cause the diagnostic unit to start operating.

### BACKGROUND OF THE INVENTION

1. Field of the Invention

The present invention relates to a self-diagnostic method and device, and more particularly to a self-diagnostic method and device for a digital television.

2. Description of Related Art

A conventional digital television(TV) has many input interfaces, such as an antenna, a cable television cable, a VGA interface and a chromatic aberration terminal (e.g. an YPbPr terminal) for a user to connect many signal generating devices such as a video recorder, a personal computer and a digital VHS (DVHS) video player. However, the user sometimes connects the signal generating devices to an improper input interface or the signal generating device is not in a normal audio/video signal generating state. Then, an image can not display on a screen of the digital television. The user is unable to determine whether the signal generating device is connected in the improper input interface, or the signal generating device or the digital television is malfunctioned. Thus, a maintenance worker has to solve a question that an image cannot display on a screen of the digital television. It is troublesome and increases maintenance cost and time.

Please refer to FIG. 1. FIG. 1 is a schematic view showing a conventional digital television set. The conventional television set comprises many input interfaces such as antenna 1, a cable television cable 2, a VGA interface 3, a YPbPr terminal 4, an high definition multimedia (HDMI) terminal 5, an AV interface 6 and an S-Video interface 7. The antenna 1 and the cable television cable 2 transmit input signals generated from external signal generating devices to a tuner 8. The VGA interface 3 and the YPbPr terminal 4 transmit input signals generated from the external signal generating devices to a converter 9. The HDMI terminal 5 transmits an input signal generated from the external signal generating device to a receiver 10. The AV interface 6 and the S-Video interface 7 transmit input signals generated from the external signal generating devices to a decoder 11. The tuner 8, the converter 9, the receiver 10 and the decoder 11 transmit output signals to a scalar 12 after receiving the input signals and processing preliminarily to be the output signals. The scalar 12 receives and adjusts the output signals and then transmits them to be displayed on a screen 13. As mentioned above, when the user connects the signal generating device to an improper input interface, for example, the DVHS video player is connected to the AV interface 26 instead of the YPbPr terminal 24, or the DVHS video player is not in a normal video/audio signal generating state, an image cannot display on the screen 13. Because the digital television is without a self-diagnostic device, the user has no way to determine whether the DVHS video player or the digital TV is malfunctioned or the input interface is connected incorrectly. Therefore, the maintenance worker has to solve the question that the image cannot display on the screen 13 of the digital television. It is troublesome and increases maintenance cost and time.

### SUMMARY OF THE INVENTION

One object of the present invention is to provide a self-diagnostic method for a digital television, capable of determining whether a processing unit in the digital television is abnormal or not.

Another object of the present invention is to provide a self-diagnostic method for a digital television, allowing a user himself to process a diagnostic for a digital television so as to reduce the maintenance cost and time.

Still another object of the present invention is to provide a self-diagnostic method, preventing a user from being unable to determine whether a signal generating device is malfunctioned or is connected to an improper relative interface, or a digital television is malfunctioned when the signal generating device is connected to the improper input interface or the signal generating device is not in a normal video/audio signal generating state.

For attaining to the objects mentioned above, a digital television according to the present invention comprises at least one input interface for transmitting input signals, at least one processing unit connected to the input interface so as to be used for receiving the input signals and outputting output signals after processing the input signals to be the output signals, a scalar connected to the processing unit and receiving, adjusting and transmitting the output signals, a screen receiving and displaying the output signals from the scalar, a diagnostic unit for generating a diagnostic signal, a storage unit, a driving unit, a starting unit for generating a starting signal and transmitting it to the diagnostic unit to cause the diagnostic unit to start operating.

### BRIEF DESCRIPTION OF THE DRAWINGS

The present invention can be more fully understood by reference to the following description and accompanying drawings, in which:

FIG. 1 is a schematic view, showing a conventional digital television set;

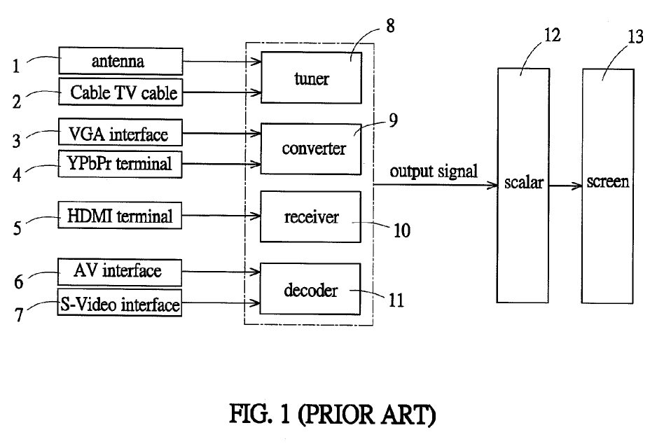

FIG. 2 is a schematic view, showing a digital television set of the present invention; and

FIG. 3 is a flow chart, showing steps of a self-diagnostic method for a digital television of the present invention.

### DETAILED DESCRIPTION OF THE PREFERRED EMBODIMENTS

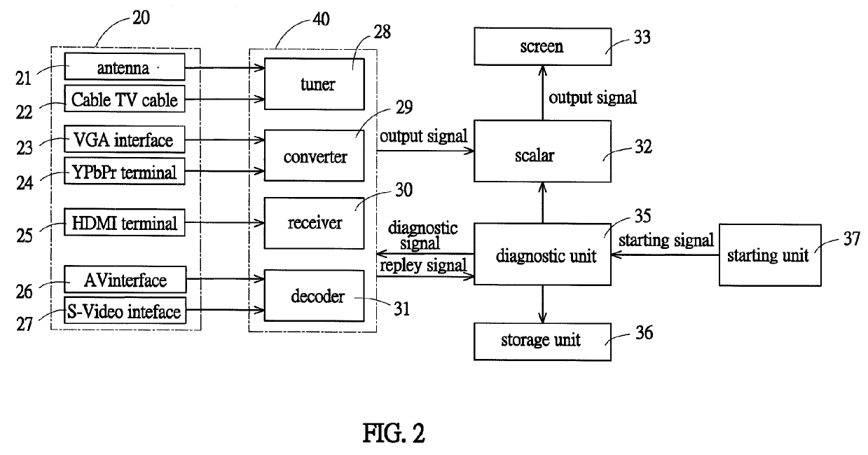

Please refer to FIG. 2. FIG. 2 is a schematic view showing a digital television set according to the present invention. The digital television comprises an input interface 20, a processing unit 40, a scalar 32, a screen 33, a diagnostic unit 35, a storage unit 36 and a starting unit 37. The input interface 20 comprises input interfaces such as an antenna 21, a cable television cable 22, a VGA interface 23, a YPbPr terminal 24, an HDMI terminal 25, an AV interface 26 and an S-Video interface 27. The processing unit 40 comprises a tuner 28, a converter 29, a receiver 30 and a decoder 31. The antenna 21 and the cable television cable 22 are connected to the tuner 28 and transmit input signals generated from external signal generating devices to the tuner 28. The VGA interface 23 and YPbPr terminal 24 are connected to the converter 29 and transmit input signals generated from external signal generating devices to the converter 29. The HDMI terminal 25 is connected to the receiver 30 and transmits input signals generated from an external signal generating device to the receiver 30. The AV interface 26 and the S-Video interface 27 are connected to the decoder 31 and transmit input signals generated from external signal generating device to the decoder 31. The tuner 28, the converter 29, the receiver 30 and the decoder 31 receive and process preliminarily the input signals into output signals. The scalar 32 is connected to the processing device 40 to receive and process the output signals from the processing device 40, and transmits the output signals to displays an image on the screen 33.

The digital television of the present invention further comprises a diagnostic unit 35, a storage unit 36 and a starting unit 37. The diagnostic unit 35 is connected to the scalar 32, the processing unit 40 and the storage unit 36. The starting unit 37 can be an on screen display (OSD) or a button of the digital television for generating a starting signal to a diagnostic unit 35. The diagnostic unit 35 can use a central processing unit (CPU), and can share the same central processing unit (CPU) with the scalar 32. The diagnostic unit 35 is used for receiving the starting signal and generating a diagnostic signal to the processing unit 40. The processing unit 40 is used for receiving the diagnostic signal and generating a reply signal to the diagnostic unit 35. The storage unit 36 can be a non-volatile random access memory (NVRAM) or electrically erasable programmable read-only memory (EEPROM) for recording the starting signal and the reply signal received by the diagnostic unit 35.

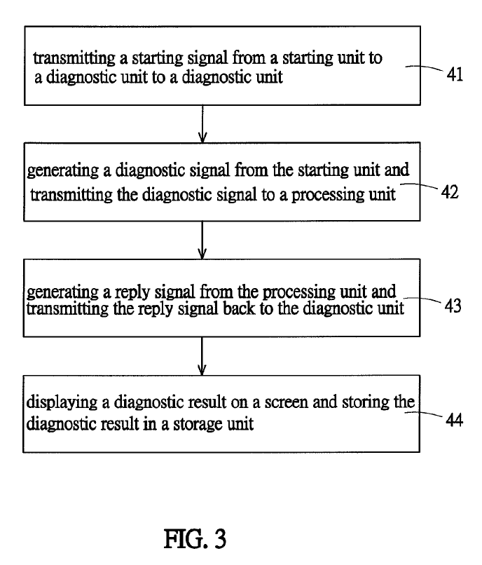

Please refer to FIG. 3. FIG. 3 is a flow chart of a self-diagnostic method executed by the elements mentioned above. The self-diagnostic method comprises the following steps:

Step 41: transmitting a starting signal from a starting unit to a diagnostic unit;

Step 42: generating a diagnostic signal from the diagnostic unit and transmitting the diagnostic signal to a processing unit;

Step 43: generating a reply signal from the processing unit and transmitting the reply signal back to the diagnostic unit; and

Step 44: displaying a diagnostic result on a screen and storing the diagnostic result in a storage unit.

Therefore, when a user connects a signal generating device to an improper input interface, for example, connects a DVHS video player to the AV interface 26 instead of the YPbPr terminal 24 that should be connected or the DVHS video player is not in a normal video/audio signal generating state, the user has no way to determine whether the DVHS video player is malfunctioned or connected to the improper input interface, or a digital television is malfunctioned. In the meantime, the user can operate the starting unit 37 to generate a starting signal to the diagnostic unit 35 to allow the diagnostic unit 35 to start operating and generate a diagnostic signal to the tuner 28, the converter 29, the receiver 30 and the decoder 31. If the tuner 28, the converter 29, the receiver 30 and the decoder 31 are in a normal state, a reply signal is generated and transmitted back to the diagnostic unit 35. If the tuner 28, the converter 29, the receiver 30 and the decoder 31 are in an abnormal state, the reply signal is not transmitted to the diagnostic unit 35. The processing unit 40 such as the tuner 28, the converter 29, the receiver 30 or the decoder 31 is in a normal state without damage through the reply signal to the diagnostic unit 35, and further the diagnostic result is displayed on the screen 33 by the scalar 32. Therefore, the user can know the diagnostic result from the screen 33 and further what state each internal element in the digital television is in. If the internal elements are in a normal state, that the DVHS video player is connected to the improper input interface or the DVHS video player is not in a normal video/audio signal generating state can be determined. After the diagnostic result is produced, the diagnostic result can be stored in the storage unit 36 for future reference when the maintenance is needed. Therefore, when a power supplier is malfunctioned or an electric power cut happens, the last diagnostic result can be known via the storage unit 36, and the last diagnostic result can be further downloaded to an external device such as a computer for analyzing through an interface such as a universal asynchronous receiver transmitter (UART). Furthermore, the oldest diagnostic result is deleted to vacate a storage space for recording the newest diagnostic result when the storage unit 36 records diagnostic results many times and exceeds a capacity of the storage unit 36.

Besides, a continuous diagnostic manner can also be adopted in the self-diagnostic method of the present invention. A timer unit is connected (not shown in the figure) to the starting unit to control the starting unit to generate a starting signal to the diagnostic unit in a predetermined time interval so as to allow the diagnostic unit to diagnostic the state of the processing unit continuously in the predetermined time interval and records the diagnostic result in the storage unit. Therefore, when the digital television is damaged and malfunctioned, the records in the storage unit can be utilized as maintaining references.

Comparing to a conventional digital television, the digital television of the present invention further comprises the diagnostic unit 35, the storage unit 36 and the starting unit 37. The user can use the method mentioned above, to diagnostic whether each processing unit in the digital television is malfunctioned and store the diagnostic results in the storage unit 36 for maintaining references so as to reduce the maintenance cost and time, and prevent the signal generating device from being connected to the improper input interface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A self-diagnostic device for a digital television, said digital television comprising at least one input interface, at least one processing unit, a scalar and a screen, said input interface being connected to said processing unit, said processing unit being connected to said scalar, and said screen for displaying images, said self-diagnostic device comprising:
a starting unit, for generating a starting signal; and
a diagnostic unit, connected to said starting unit, said scalar and said processing unit, said diagnostic unit receiving said starting signal and generating a diagnostic signal to said processing unit, and said processing unit generating a reply signal and transmitting said reply signal back to said diagnostic signal.

2. The self-diagnostic device according to claim 1, wherein said scalar processes said reply signal to display on said screen.

3. The self-diagnostic device according to claim 1, further comprising a storage unit for storing said reply signal.

4. The self-diagnostic device according to claim 1, wherein said input interface is an antenna, a cable television cable, a VGA interface, a chromatic aberration terminal, an HDMI terminal, an AV interface, or an S-video interface.

5. The self-diagnostic device according to claim 1, wherein said processing unit is a tuner, a converter, a receiver or a decoder.

6. The self-diagnostic device according to claim 1, wherein said storage unit is a non-volatile random access memory (NVRAM) or an electrically erasable programmable read-only memory (EEPROM).

7. The self-diagnostic device according to claim 1, wherein said starting unit is an on screen display (OSD) or a button disposed on said digital television.

8. A self-diagnostic method for a digital television, said digital television comprising at least one input interface for transmitting a input signals, at least one processing unit connected to said input interface to receive said input signals and outputting output signals after processing said input signals to be said output signals, a scalar connected to said processing unit and receiving, adjusting and transmitting said output signals, a screen for displaying said output signals from said scalar, a diagnostic unit connected to said processing unit for generating a diagnostic signal, a storage unit connected to said diagnostic unit, and a starting unit connected to said diagnostic unit for generating a starting signal to said diagnostic unit, said self-diagnostic method comprising the following steps:
Transmitting said starting signal from said starting unit to said diagnostic unit;
Transmitting said diagnostic signal to said processing unit after said diagnostic unit generates said diagnostic signal;
Transmitting a reply signal back from said processing unit to said diagnostic unit after said processing unit generates said reply signal; and
Displaying a diagnostic result according to said reply signal on said screen through said scalar.

9. The self-diagnostic method according to claim 8, wherein said diagnostic result is stored in said storage unit.

10. The self-diagnostic method according to claim 9, wherein when said storage unit accumulates said diagnostic results up to full storage, an oldest diagnostic result is deleted and replaced with a newest diagnostic result.

11. The self-diagnostic method according to claim 9, wherein said diagnostic results stored in said storage unit do not disappear owing to a power failure.

12. The self-diagnostic method according to claim 9, wherein said diagnostic results stored in said storage unit are downloadable to an external device through a connection interface.
